(19) United States
(12) Patent Application Publication
(10) Pub. No.: US 2001/0001478 A1
(43) Pub. Date: May 24, 2001

(54) FIRE-FIGHTING AGENTS CONTAINING POLYSACCHARIDES AND FLUOROCHEMICAL OLIGOMERIC SURFACTANTS

(75) Inventors: RUDOLF J. DAMS, ANTWERP (BE); WIM J. VANNESTE, ZWIJNAARDE (BE)

Correspondence Address: 3M OFFICE OF INTELLECTUAL PROPERTY, COUNSEL, P O BOX 33427, ST PAUL, MN, 551333427

(73) Assignee: Rudolf J. Dams and Wim J. Vanneste

(21) Appl. No.: 08/850,453

(22) Filed: May 5, 1997

(51) Int. Cl. A62C 2/00; C09K 21/14

(52) U.S. Cl. 252/2; 252/3; 169/43; 169/46; 252/6.5; 252/8.05

(57) ABSTRACT

The subject matter of the invention is a fire-fighting concentrate composition comprising

(a) a fluorochemical oligomer having a plurality of pendent fluoroaliphatic groups,

(b) one or more fluorochemical surfactants and one or more non-fluorinated surfactants,

(c) a polysaccharide,

(d) water, and

(e) optionally a polymeric stabilizer and thickener other than a polysaccharide, one or more water-soluble organic solvents, and other usual additives.

The fire-fighting concentrate composition of the invention is a stable low viscosity 3×3 fire-fighting composition having excellent fire extinguishing performance against fires of both polar and non-polar solvents.

### FIELD OF THE INVENTION

The present invention relates to fire-fighting compositions. More particularly it relates to low viscosity fire-fighting foam compositions, especially “3×3” (three by three) concentrates. The low viscosity compositions of the present invention are found to have excellent fire-extinguishing properties against both polar and non-polar solvent fires.

### BACKGROUND OF THE INVENTION

Various fire-extinguishing foams have been developed for use against fires of non-polar solvents or liquids such as gasoline, kerosene, light oils, heavy oils and crude oils. Many of these fire-extinguishing concentrates provide film-forming characteristics on the surface of a non-polar hydrophobic liquid. The use of fluorochemical surfactants is taught in U.S. Pat. Nos. 3,475,333; 4,472,286; 4,460,480 and 4,717,744. A fire-extinguishing composition which includes them can form a thin aqueous film on the surface of a flammable liquid and inhibit the reignition of the flammable liquid once extinguished by the foam. The fluorochemical surfactants in the aforementioned patents are incorporated into protein-based fire-fighting compositions in order to impart improved properties such as increased foam mobility, reduced extinguishing times and reduced fuel pick-up. These compositions are useful for fighting fires of burning hydrophobic or non-polar hydrocarbon liquids.

However, when such fire-extinguishing foams are applied to fires of polar solvents such as alcohols, ketones, esters, ethers and amines, the foam collapses due to water drainage from foam lamellae. Polar solvents penetrate the aqueous foam and speed up water drainage. Certain water-soluble polymers slow down this penetration, and thus slow down the foam collapse. For this reason, fire-fighting foam concentrates for polar solvents generally contain as a key component water-soluble or swellable polymeric materials, e.g., polysaccharides or protein hydrolysates. They cause the aqueous foam to form a gelatinous ‘mat’ or membrane when it comes in contact with a polar hydrophilic liquid.

U.S. Pat. Nos. 3,957,657; 4,420,434; 4,424,133; 4,387,032; 4,306,979; 4,060,489; 4,464,267 and 4,060,132 describe the use of thixotropic polysaccharide gums in fire-fighting compositions for polar solvent fires. Such foams form a membrane on the surface of the polar solvent that protects the rest of the foam from collapsing. Protein hydrolysates can be used in combination with polysaccharide gums to fight polar-solvent fires. The use of non-oligomeric ampholytic sulphonamide fluorochemical surfactants with hydrolyzed protein and polysaccharide gums to fight polar solvent fires has been described in U.S. Pat. No. 4,424,133.

U.S. Pat. Nos. 4,303,534 and 4,563,287 describe the use of aqueous fire-fighting compositions comprising a water-soluble high molecular weight compound which contains fluoroalkyl groups and water-solubilizable groups, having a molecular weight of not less than 5,000 and a fluorine content of not less than 10% by weight, and which is soluble in water in an amount of at least 0.1% by weight at 25° C. as an additive to a foam fire-extinguishing agent, particularly for fires of polar organic solvents (U.S. '534) and cooking oil (U.S. '287), respectively. The foam fire-extinguishing agent to which the compound having fluoroalkyl groups is added may be any conventional one such as a fluorine-containing surfactant, a synthetic surfactant containing no fluorine atom or a partially hydrolyzed protein-containing foam agent.

U.S. Pat. No. 5,218,021 teaches perfluoro-terminated-cooligomers derived from perfluoroalkyl radicals and non-ionic hydrophilic and anionic hydrophilic monomers via free radical co-oligomerization. The cooligomers are useful as additives in polar-solvent fire-fighting compositions when used in conjunction with polysaccharides and other adjuvants.

U.S. Pat. No. 5,391,721 describes aqueous film-forming foam (AFFF) concentrates for fighting polar and non-polar fuel and solvent fires, comprising hydrocarbon solvents, hydrocarbon surfactants, fluorosurfactants, high molecular weight polysaccharides, alginates, salts of aryl or alkylaryl sulfonates and water, and a method for modifying the viscosity of the AFFF concentrates.

JP-A-2121681 (1990) discloses a protein foam fire-extinguishing agent, which contains a cationic or amphoteric fluorine-containing oligomer having an average molecular weight of 4000 or lower. The oligomer is ionically reacted with protein to give a fluorinated protein which is suitably soluble in water and easily foamed without precipitation; the foam is hardly soluble in polar solvents. The agent is particularly suitable for extinguishing fire of polar solvents.

WO 94/18245 describes novel water-soluble polyperfluoroalkylated surfactants derived from polycarboxylic functional polymers and having oil and alcohol repellent properties enabling their use in synthetic or protein-based extinguishing foam compositions for putting out not only burning hydrocarbons but also burning polar liquids (alcohols, ethers, esters, etc.) without requiring thickening agents such as polysaccharides.

Multi-purpose non-polar and polar-solvent fire-fighting foam concentrates are typically formulated to be diluted (proportioned) to different concentrations for use on different types of fires. For fires involving non-polar fuels such as hydrocarbon liquids, the concentrates are proportioned at the point of application through the foam nozzle to the 3% level (3 parts concentrate with 97 parts fresh or salt water). Fires involving polar solvents require a dilution to 6%. These products are known in the industry as “3×6” (“three by six”) products.

Recent advances in polar-solvent fire-fighting formulation technology have made it possible to formulate concentrates that can be diluted at a single proportioning level of 3% for all uses. These products are known as “3×3” (“three by three”) products. Among the well known advantages of these 3×3 products are savings in storage space, and savings in cost through the reduced usage level of the concentrate. These products can also eliminate the need on the part of the fire-fighters to identify the fuel type in emergency situations; because only one, single proportioning setting at 3% is required for either polar solvent or hydrocarbon fires. With the 3×6 type of products, the fuel type (i.e., whether the burning fuel is a polar, hydrophilic liquid or a hydrocarbon) has to be identified before the fire-fighter can properly set the foam proportioning device at either 6% or 3%.

One of the major disadvantages of a 3×3 agent vs. a 3×6 agent is that high amounts of polysaccharide have to be used in the concentrate to get the desired fire-fighting performance. These high amounts of polysaccharides lead to high viscosities, ranging between 4000 and 5000 cps. These high viscosity materials are hard to transport by pumps, to uniformly dilute with water before use and to remove entrapped air leading to problems when material is loaded in storage tanks (too much foam is generated, due to air entrapment, during loading which will result in the fact that storage tank can only partially be filled). High amounts of polysaccharide can also lead to metastable systems with low initial viscosity (e.g., between 600-800 cps) that during aging over time, especially with heat or in contact with even small amounts of water (air humidity, condense water, residual water in storage tanks), show a significant rise in viscosity (up to 3000 cps and more). This dramatic change in viscosity makes these materials unreliable, because viscosities in reality are much higher than expected (e.g., causing pumping problems). The fact that these materials are metastable makes them unpredictable and inconsistent, which is a very negative point in fire-fighting where surprises in equipment and materials must be lowered to the strict minimum. A need thus exists for a stable, low viscosity 3×3 agent containing only low amounts of polysaccharide.

### SUMMARY OF THE INVENTION

Briefly, in one aspect, the present invention provides a fire-fighting concentrate composition comprising

a) a fluorochemical oligomer having a plurality of pendent fluoroaliphatic groups,

b) one or more fluorochemical surfactants and one or more non-fluorinated (e.g., hydrocarbon) surfactants;

c) a polysaccharide;

d) water; and

e) optionally, a polymeric stabilizer and thickener other than a polysaccharide, one or more water-soluble organic solvent, and other usual additives.

In a further aspect, the invention provides a method of extinguishing polar or non-polar liquid fires, which comprises the steps of diluting, aerating and applying to the surface of said liquid an effective amount of the fire-fighting concentrate composition for extinguishing said fire.

The aqueous fire-fighting composition of the present invention comprising a fluorochemical oligomer having a plurality of pendent fluoroaliphatic groups, one or more fluorochemical surfactant, one or more non-fluorinated surfactant and a polysaccharide provides a unique solution to the problems encountered in the prior art, wherein contradictory information can be found as regards suitability of different types of fluorochemical oligomers for use together with other components of a fire-fighting composition.

U.S. Pat. No. 4,303,534, for example, describes an aqueous fire-fighting composition having a water-soluble high molecular weight additive which contains pendant fluoroalkyl groups and water-solubilizable groups together with a partially hydrolyzed protein-containing foaming agent. Use of the fluoroalkyl-group-containing high molecular weight additive together with a polysaccharide in a fire-fighting composition is not mentioned in these patents. These patents also teach that the molecular weight of the high molecular weight additive must not be less than 5,000, and preferably not less than 10,000, because otherwise stable foams are not formed on the surface of a polar organic solvent, and foams of good heat resistance are not produced on the surface of a petrolic solvent.

U.S. Pat. No. 5,218,021 teaches the use of cooligomers having terminal perfluoroalkyl moieties as additives in polar solvent, fire fighting compositions in conjunction with polysaccharides and other additives. This patent states that the perfluoroalkyl, high molecular weight polymers according to U.S. Pat. Nos. 4,303,534 and 4,563,287 which contain perfluoroalkyl groups interspersed randomly along the polymeric backbone are not as efficient as cooligomers having terminal perfluoroalkyl groups. It is also said that the cooligomers interact with polysaccharides in a synergistic manner due to strong association of the co-oligomers with the polysaccharides.

Accordingly, U.S. Pat. Nos. 4,303,534, 4,563,287, and 5,218,021 teach away from the instant invention because, while compounds containing pendent fluoroalkyl groups may be useful as additives in certain foam fire-extinguishing agents for combating polar organic solvents fires (provided that they have a relatively high molecular weight), these perfluoroalkyl-group-containing compounds are said to be less efficient when used in compositions comprising polysaccharides, where cooligomers having only terminal perfluoroalkyl groups are said to be superior.

It has now surprisingly been found that fluorochemical oligomers having a plurality of pendent fluoroaliphatic groups, when used together with a polysaccharide, have excellent fire fighting properties in 3×3 formulations. Also surprisingly the fluorochemical oligomers having a plurality of pendent fluoroaliphatic groups in the fire-fighting compositions of the present invention are not restricted to compounds having a molecular weight of not less than 5,000 as even compounds having a molecular weight as low as 2,000 have excellent fire-fighting properties for both polar and non-polar solvent fires when used in combination with a polysaccharide.

Also in the present invention a synergism is observed when both fluorochemical oligomer and polysaccharide are used in the fire-fighting concentrate composition. However, it is believed that this synergism is not caused by strong interaction between the oligomer and the polysaccharide as is taught in U.S. Pat. No. 5,218,021, since the same observation was made with the currently preferred amphoteric fluorochemical oligomers.

A further surprising advantage of the compositions of the present invention comprising fluorochemical oligomer having a plurality of pendent fluoroaliphatic groups and polysaccharide is, that, whereas the preferred compositions of U.S. Pat. No. 5,218,021 (3×6 formulations) comprise polysaccharide up to 10% by weight, compositions of the present invention use polysaccharide at concentrations of 3% or less, and preferably 1.5% or less, by weight. The fluorochemical oligomers used in the composition of the present invention boost the polar solvent resistance dramatically, allowing for reduction of polysaccharide levels and leading to advantageously low viscosity of the concentrate composition.

### DETAILED DESCRIPTION OF THE INVENTION

Fluorochemical oligomers useful in the fire-fighting compositions of the present invention have a plurality of pendent fluoroaliphatic groups (R_{f}) and water solubilizing moieties are usually connected together by suitable linking groups.

The fluoroaliphatic group (R_{f}) in the oligomer can generally be described as a fluorinated, preferably saturated, monovalent, non-aromatic group of at least 3 carbon atoms. The aliphatic chain may be straight, branched, or, if sufficiently large, cyclic and may include oxygen, hexavalent sulfur, or trivalent nitrogen atoms bonded only to carbon atoms. A fully fluorinated group is preferred, but hydrogen or chlorine atoms may be present as substituents provided that not more than one atom of either is present for every two carbon atoms. While groups containing a large number of carbon atoms will function adequately, compounds containing not more than about 20 carbon atoms are preferred since larger groups usually represent a less efficient utilization of fluorine than is possible with shorter chains. Fluoroaliphatic groups containing about 5 to 12 carbon atoms are most preferred.

The water-solubilizing polar group or moiety of the fluorochemical oligomer can be an anionic, cationic, non-ionic or amphoteric moiety, or combinations of said groups or moieties which may be the same or different. Typical anionic groups include COOH, COOM, SO₃M, OSO₃H, OSO₃M, OPO(OH)₂ and OPO(OM)₂, where M is a metal ion (such as sodium or potassium), an ammonium ion, or other amine cation. Typical cationic groups include: NH₂, NHR, and NR₂, where R is a lower alkyl group such as methyl, ethyl or butyl; and R′₃NA′, where R′ is a lower alkyl group or hydrogen, and A′ is an anion such as chloride, sulphate, phosphate or hydroxyl. Typical non-ionic groups include poly(oxyalkylene) moieties, e.g., those derived from polyethylene oxide, polypropylene oxide and mixtures thereof Typical amphoteric groups would include N⁺(CH₃)₂C₂H₄COO⁻, N⁺(CH₃)₂C₃H₆SO₃⁻ and NR₂→O (amine oxide). The water-solubilizable group or moiety is preferably non-ionic or amphoteric. Amine oxides are highly preferred.

The linking group is a multivalent, generally divalent, linking group such as an alkylene, arylene, sulfonamidoalkylene, carbonamidoalkylene or other heteroatom-containing group such as siloxane, including combinations of such groups.

The fluorochemical oligomers are preferably non-ionic or amphoteric. They have about 5 to 45 weight percent, preferably about 20 to 40 weight percent of carbon-bonded fluorine, based on the weight of the oligomer, the fluorine content residing in said plurality of pendent fluoroaliphatic radicals. These materials are relatively low molecular weight linear polymers, or lightly crosslinked polymers, containing from 3 to 4 up to about 25 or 30 monomer units, and thus are “oligomeric”, as contrasted to “high polymers” having a molecular weight of 100,000 or higher.

A particularly useful class of fluorochemical oligomers falling under the above general description are polyacrylates. Examples of this class of fluorochemical oligomers can be prepared by copolymerizing any of the known fluorochemical (meth)acrylates and optionally (meth)acrylamides, such as those described in U.S. Pat. No. 5,098,446 (table 1, column 6) or those described in U.S. Pat. No. 5,453,540 (columns 14 and 15), with fluorine-free (meth)acrylates and optionally (meth)acrylamides such as those described in U.S. Pat. No. 5,453,540 (columns 15 and 16).

The ratio of fluorochemical monomer to fluorine-free monomer may vary in order to obtain substantial water solubility of the oligomer and in order to get a maximum foam stabilizing effect. The ratio will vary depending on the specific monomer combination used. Preferably, the fluorochemical oligomer is soluble in water in an amount of at least 0.5% by weight of the oligomer. Fluorochemical oligomers have been described for example, in U.S. Pat. Nos. 4,668,406, 3,787,351 and 5,098,446.

The fluorochemical oligomers can be prepared by methods known to those skilled in the art. Preferably the oligomers will be prepared by free radical polymerization in the presence of a chain transfer agent in order to control the molecular weight. Useful initiators include organic peroxides, such as benzoyl peroxide, lauryl peroxide and various thermal initiators. Preferred thermal initiators include 2,2′-azobisiosbutyronitrile (ABIN), commercially available from E. I. DuPont de Nemours under the trade name Vazo™64, and 2,2′-azobis(2,4-dimethylvaleronitrile), available from Wako under the trademark V-65. The initiator is present in an amount of from about 0.01 to 2 parts based on 100 parts of total monomer content. Useful chain transfer agents include mercaptans, alcohols, and carbon tetrabromide. The chain transfer agent is present in an amount of from about 0.1 to about 6 parts based on 100 parts per total monomer content.

The fluorochemical oligomers of this invention have an average molecular weight between about 2000 and about 50,000, preferably between about 2000 and about 20,000, most preferably between about 2000 and about 10,000. The fire-fighting composition of the present invention will comprise from about 0.3 to about 5% by weight of the fluorochemical oligomer, preferably between about 0.5 and 4%.

The concentrate composition of the present invention also comprises one or more fluorochemical surfactants (which gives low surface tension) which may be anionic, cationic, nonionic or amphoteric, and one or more nonfluorinated (e.g., hydrocarbon) surfactants (which makes the foam) which may be anionic, cationic, amphoteric or nonionic as is known in the art and described in, e.g., U.S. Pat. No. 5,085,786 (columns 4-8) and U.S. Pat. No. 5,359,096 (columns 5-7). In this composition, the fluorochemical surfactant is used in an amount of from about 1 to about 6% by weight, preferably between about 1.5 and about 4% by weight; and the nonfluorinated surfactant is used in an amount of from about 1 to about 10% by weight, preferably in an amount of from about 2 to about 8% by weight.

The concentrate composition of the present invention also comprises a polysaccharide, preferably an anionic heteropolysaccharide having a high molecular weight. Commercially available polysaccharides useful in the invention include those sold under the trademarks, e.g., Kelzan™ and Keltrol™ (available from Kelco). The polymeric structure is not critical for the purposes of this invention. Only a small amount of polysaccharide is required to confer a noticeable change in properties. The polysaccharide is used in an amount of from about 0.1 to about 3% by weight of the concentrate composition, preferably between about 0.2 and 1.5%.

Optionally, other polymeric stabilizers and thickeners can be incorporated into the concentrate compositions of the invention to enhance the foam stability of the foam produced by aeration of the aqueous solution made from the concentrate. Examples of suitable polymeric stabilizers and thickeners are partially hydrolyzed protein, starches and modified starches, polyacrylic acid and its salts and complexes, polyethyleneimine and its salts and complexes, polyvinyl resins, e.g., polyvinyl alcohol, polyacrylamides, carboxyvinyl polymers, and poly(oxyethylene)glycol. When used, the optional polymeric stabilizers and thickeners will be added in an amount of from about 0.1 to about 5%, preferably between about 0.2% and 1.5% by weight of the concentrate.

The concentrate compositions of the invention contain water and preferably include water-soluble solvents to facilitate solubilization of the fluorochemical oligomer surfactants and the other components. The solvents also may act as foam stabilizers, freeze protection agents and shelf life enhancers. Suitable solvents include ethylene glycol, diethylene glycol, glycerol, ethyleneglycol monoethylether, diethyleneglycol butylether, dipropyleneglycol monopropylether, dipropyleneglycol monomethylether, methoxy propylene glycol and hexylene glycol. A suitable range of cosolvents in the concentrates of the invention is from 1 to 50 parts, preferably from 4 to 30 parts, by weight per 100 parts of concentrate.

Other ingredients, known to those skilled in the art, that are usually employed in fire-fighting compositions may be employed in the concentrate compositions of this invention. Examples of such ingredients are preservatives, buffers to regulate pH (e.g., tris(2-hydroxyethyl)amine or sodium acetate) and corrosion inhibitors (e.g., toluoltriazole or sodium nitrite).

The composition of the invention is employed in the usual way to combat fires of flammable liquids or to prevent evaporation of flammable vapours. The composition is particularly suitable for application in the form of a foam. Usually it is stored in the form of an aqueous concentrate only requiring dilution to 3% concentration with either fresh or sea water to form the “premix” and aeration of the premix to produce a foam which is applied to the burning liquid surface.

Objects and advantages of this invention are further illustrated by the following examples, but the particular materials and amounts thereof recited in these examples, as well as other conditions and details, should not be construed to unduly limit this invention.

### EXAMPLES

Test methods

The following tests have been done to evaluate the foam properties of the compositions of the present invention.

Foam Stability Test

Foams were produced by making 100 ml of a 3% foam premix by diluting by weight 3 parts foam concentrate with 97 parts fresh or with synthetic sea water (composition according to ASTM D1141-52), and foaming the resultant premix using a Kalorik-type 5353 kitchen mixer at highest speed for 1 minute. Then 50 g of each foam was poured over a 30 second time period onto 250 g solvent contained in a 19 cm diameter×8 cm high glass dish. The foam was poured onto the solvent in such a way that it spread over and across the solvent from one end of the dish to the other and completely covered the surface of the solvent. The time required for 50% of the foam area to collapse from the first moment the foam touched the solvent was recorded as T^{½} (solvent). Both acetone and isopropanol were used as representative polar solvents.

Foam Expansion/Drain Time

Foam expansion and drain time were measured in accordance with US Department of Defense Military Specification No. MIL-F-24385, Revision F, Section 4.7.5, using the standard National Foam Systems 2 gal/min nozzle.

Surface Tension and Interfacial Tension

The surface and interfacial tension were measured with a Du Nouy Tensiometer according to ASTM D-1331.

Brookfield Viscosity

The Brookfield Viscosity was measured using a Brookfield LVT viscosimeter using a number 3 spindle at a rotational speed of 30 rpm in a water bath set at 20° C. The viscosity was recorded after 60 seconds.

Fire-Fighting Tests

Lab scale

The concentrate of the present invention was diluted to a 3% premix with fresh water (i.e., tap water) or with synthetic sea water (composition according to ASTM D1141-52). 150 ml of this 3% solution was foamed in a kitchen blender for 30 seconds, after which the foam was immediately transferred to a glass flask. Using air pressure, the foam was forced from the flask and passed through a plastic tube to 250 ml of burning polar solvent in a circular metal pan of 0.021 m² area. The solvent pre-burn time was 40 seconds. The time required for extinguishing the burning liquid was recorded.

Nordtest Type 023

The fire-fighting properties of the foams made from the concentrates of the present invention have been tested on a large scale according to a modified Nordtest Type 023. Test conditions:

A circular pan with an area of 2.65 m² was filled with 180 l of fuel. The nozzle used was a modified National Foam nozzle with flow rate 11.4 l/min. The fuel pre-burn time was 60 seconds and the foam was applied for a total of 4 minutes. A visual observation was done after 50%, 90%, 99% and 100% (complete fire-extinguishment) foam coverage. The hold time before running the ‘burnback’ test, i.e., the time after completion of foam application, was 1 minute. A visual observation of 50% burnback time was done.

Film Spreading Test

Cyclohexane was poured in a petri dish having 10 cm diameter and 1 cm height until the cyclohexane reached a depth of 0.5 cm. Twenty drops of a 3% premix was put gently on the cyclohexane surface using an eyedropper over a period of about 20 seconds. The film formed was allowed to spread during 30 sec. A burning match was passed over the dish. If the cyclohexane did not ignite, the film passed the vapor sealing.

Abbreviations The following abbreviations, trade names and trademarks were used in the examples:

EtFOSEMA: N-ethylperfluorooctylsulfonamidoethylmethacrylate, available from Minnesota Mining and Manufacturing Company, St. Paul, Minn., U.S.A. (3M)

MeFOSEMA: N-methylperfluorooctylsulfonamidoethylmethacrylate, available from 3M

DMAEMA: N,N-dimethylaminoethylmethacrylate, available from Aldrich Chemical Company, Inc., Milwaukee, Wis., U.S.A.

AMPS-EOA: monoethanolamine salt prepared from 2-acrylamido-2-methylpropane sulfonic acid, available from Aldrich

P144DA: A diacrylate made from Pluronic™ 44, which is available from BASF Aktiengesellschaft, Ludwigshafen, Germany

CW75OA: An acrylate made from Carbowax™750, C₈F₁₇SO₂N(C₂H₅)C₂H₉OCOC(CH₃)CH₂ according to the procedure described in U.S. Pat. No.3,787,351, Example 2. Carbowax™750 is available from British Petroleum International Limited, London, United Kingdom

AA-EOA: acrylic acid - ethanol amine salt

HOEMA: hydroxyethylmethacrylate

CW400DMA: A diol dimethacrylate, made from Carbowax™ 400, which can be prepared using the procedure described in U.S. Pat. No. 3,787,351, Example 1, except substituting Carbowax™ 400 for Pluronic™44. Carbowax™400 is available from British Petroleum International Limited, London, United Kingdom

DMAPMA/chloroethanol: N,N-dimethylaminopropyl methacrylamide (available from Aldrich), quaternized to 100% by chloroethanol

SOS: sodium octyl sulphate

SDS: sodium decyl sulphate

BC: Carbitol™ ether, a diethylene glycol butyl ether

DPM: dipropylene glycol monomethyl ether

DPnP: dipropylene glycol monopropyl ether

DMF: dimethylformamide

NMP: N-methylpyrrolidinone

EtOAc: ethyl acetate

foamer: C₈F₁₇SO₃⁻K⁺, a fluorochemical surfactant as described in U.S. Pat. No. 5,085,786, column 5, line 68, and available from 3M Company

Witcolate™ 7093 surfactant: a C₆-C₁₀ alkyl ether sulfate surfactant, available from Witco

Kelzan™ gum: a polysaccharide (xantham gum), available from Kelco

Ansulite™ 3×3 low viscosity agent (Ansul, USA)

Finiflam™ 3×3 fire-fighting agent (Pirna, Germany)

Towalex™ 3×3 freeze-protected fire-fighting agent

All parts, ratios, percentages, etc., in the following examples are by weight unless otherwise specified.

### Examples 1-14 and Comparative Examples C1-C4

A. Synthesis of the fluorochemical oligomers

1. Fluorochemical oligomer oxides FC-1 to FC-9

The fluorochemical oligomers identified in Table 1 were prepared according to the general procedure as described below for the synthesis of the fluorochemical oligomer EtFOSEMA/DMAEMA-N-oxide with a monomer ratio (wt) of 60/40.

In a 500 ml, three-necked flask fitted with a condenser, stirrer and thermometer were placed 60 g EtFOSEMA, 40 g DMAEMA, 5 g n-octyl mercaptan (RSH), 1 g ABIN and 100 g isopropyl alcohol. The flask was deaerated with nitrogen under vacuum for 3 times. The mixture was heated and the reaction was carried out under nitrogen at 75° C. for 16 hours. After the reaction was completed, the solvent was stripped at a temperature of 60-80° C. under aspirator vacuum. The reaction mixture was cooled to about 45° C. after which 80 g ethylene glycol and 20 g BC were added. 29.7 g of hydrogen peroxide (35% active in water) was added in small increments over a period of one hour. An immediate exotherm was noticed. The reaction was continued for another 3 hours at 45° C., then for 3 hours at 65° C. and finally for 1 hour at 90° C. The reaction mixture was diluted to 30% solids using 103 g deionized water. A slightly hazy, yellow solution was obtained, containing an oligomeric fluorochemical amine oxide having a weight average molecular weight of 4400. The pH of the solution was adjusted to 7 using a 10% aqueous solution of sodium hydroxide.

Following the above described method, different fluorochemical amine oxides as given in Table 1 have been synthesized.

TABLE 1
Composition of EtFOSEMA/DMAEMA-N-OXIDE oligomers

| FC | Monomer ratio | % | | Weight |
|---|---|---|---|---|
| oligomer | EtFOSEMA/DMAEMA | ABIN | % RSH | Average MW |
| FC-1 | 60/40 | 1 | 10 | 2200 |
| FC-2 | 60/40 | 1 | 5 | 4400 |
| FC-3 | 60/40 | 1 | 5 | 4800 |
| FC-4 | 60/40 | 1 | 1 | 9500 |
| FC-5 | 60/40 | 1 | 0 | 18300 |
| FC-6 | 60/40 | 0.2 | 0 | 43000 |
| FC-7 | 70/30 | 0.8 | 5 | 4500 |
| FC-8 | 30/70 | 0.8 | 5 | 4400 |
| FC-9 | 60/40 | 0.8 | 5 | 5100 |

Note:
For each oligomer, the reaction solvent used was isopropanol, except for FC-3 in which N-methylpyrrolidinone was used.

In all examples given above, the fluorochemical oligomer oxide was obtained as 30% solids in a mixture of ethylene glycol (24%), BC (6%) and water (40%), except for FC-3. In the synthesis of FC-3, the solvent was not stripped after the first reaction and the fluorochemical oligomer FC-3 was obtained as 30% solids in a mixture of NMP (30%) and water (40%).

2. Fluorochemical oligomers FC-10 to FC-14

Fluorochemical oligomers FC-10 to FC-14 were made using the general procedure outlined below:

In a 500 ml, three-necked flask fitted with a condenser, stirrer and thermometer were placed the monomers, initiator and chain transfer agents as listed in Table 2. The flask was deaerated with nitrogen under vacuum for 3 times. The mixture was heated and the reaction was carried out under nitrogen at 75° C. for 16 hours. After the reaction was completed, the solvent was optionally (as indicated in Table 2) stripped at a temperature of 60-80° C. under aspirator vacuum. The reaction mixture was diluted to 30% solids using solvent mixtures as given in Table 2. The pH of the solution was always adjusted to about 7.

TABLE 2
Composition of fluorochemical oligomers

| | Monomer | Chain | | | | Weight |
|---|---|---|---|---|---|---|
| FC- | mixture | Transfer | % | Solvent | Final | average |
| No. | (Ratio) | (5%) | ABIN | reaction | solvent | MW |
| FC-10 | EtFOSEMA/ | Octyl- | 1 | DMF | DMF/ | 5,000 |
| | AMPS- | mercap- | | | Water | |
| | EOA/P144DA | tan | | | 30/40 | |
| | (60/20/20) | | | | | |
| FC-11 | EtFOSEMA/ | Octyl- | 0.8 | EtOAc | EG/BC/ | 4,700 |
| | CW750A | mercap- | | (1) | Water | |
| | (60/40) | tan | | | 26/6/40 | |
| FC-12 | EtFOSEMA/ | Thio- | 0.8 | IPA | EG/BC/ | 4,200 |
| | AA- | glycerol | | (1) | Water | |
| | EOA/HOEMA | | | | 24/6/40 | |
| | (70/15/15) | | | | | |
| FC-13 | MeFOSEMA/ | Mer- | 1 | IPA | EG/BC/ | 4,400 |
| | CW4000DMA | capto- | | (1) | Water | |
| | (50/50) | ethanol | | | 24/6/40 | |
| FC-14 | BuFOSEA/ | Mer- | 1 | NMP | NMP/ | 4,500 |
| | DMAPMA- | capto- | | | Water | |
| | chloroethanol | ethanol | | | 30/40 | |
| | (60/40 | | | | | |

Note:
(1): solvent stripped

B. Evaluation of fluorochemical oligomers in fire-fighting foam agents

Foams were made comprising the fluorochemical oligomers described above. The foams were first prepared by mixing water (85.5%) with 0.5% Kelzan gum and 5% BC, whereby a viscous solution was obtained. Then 2% foamer, 1% C₈F₁₇SO₃⁻K⁺, 4% Witcolate 7093 surfactant and 2% fluorochemical oligomer were added (each percentage based on solids by weight) and the mixture was stirred for 2 hours at 60° C. A clear brown solution with a Brookfield viscosity (spindle 3) between 700-800 cps was obtained. The foams thus prepared were used in the following examples.

Examples 1 to 14 were made by diluting 3 g of the concentrates prepared above to 100 g using tap water to provide a 3% foaming agent premix. Comparative examples C-1 and C-2 were made according to the procedures described in U.S. Pat. No. 4,303,534, example 2, and U.S. Pat. No. 4,460,480, Example 1, respectively. The foam agents of Comparative Examples C-3 and C-4 were made the same way as the foam agent of Example 2, except that no polysaccharide was added in C-3 and no fluorochemical oligomer was used in C-4. The 3% foam agents were tested for their foam stability according to the foam stability test described above and using acetone and isopropanol as solvents. The results of the test are provided in Table 3.

TABLE 3
Foam Stability Test

| | | T^{1/2}acetone, | T^{1/2}IPA, |
|---|---|---|---|
| Ex. No. | FC Oligomer | min:sec | min:sec |
| 1 | FC-1 | 32:10 | 38:00 |
| 2 | FC-2 | 39:40 | 45:10 |
| 3 | FC-3 | 35:20 | — |
| 4 | FC-4 | 25:10 | — |
| 5 | FC-5 | 12:30 | — |
| 6 | FC-6 | 6:50 | — |
| 7 | FC-7 | 43:50 | — |
| 8 | FC-8 | 7:40 | — |
| 9 | FC-9 | 31:40 | — |
| 10 | FC-10 | 32:45 | 35:40 |
| 11 | FC-11 | 30:10 | — |
| 12 | FC-12 | 12:30 | — |
| 13 | FC-13 | 26:00 | — |
| 14 | FC-14 | 30:20 | 30:50 |
| C-1 | — | 2:20 | — |
| C-2 | — | 4:30 | 6:30 |
| C-3 | FC-2(*) | 2:40 | 3:00 |
| C-4 | — | 5:50 | — |

Note:
(*):Fluorochemical oligomer of Example 2 was used without polysaccharide in the foam concentrate.

The data in Table 3 indicate that formulations comprising fluorochemical oligomers according to the invention provide foams which are very resistant to an aggressive polar solvent such as acetone. The formulations according to the invention are superior to the state-of-the-art formulations containing fluorochemical oligomers having only terminal fluorinated R-groups (Comparative Example C-2) or containing fluorochemical oligomers of high molecular weight and lower fluorine level such as in Comparative Example C-1. Comparative Example C-3 indicates that foam made using the fluorochemical oligomer of Example 2, but with no added polysaccharide, shows poor resistance against polar solvents. Comparative Example C-4 indicates that foam made with only polysaccharide and no fluorochemical oligomer also has low foam stability in contact with a polar solvent. The fluorochemical oligomer with the polysaccharide improves the foam stability considerably.

### Examples 15 to 19 and Comparative Examples C-5 to C-10

In Examples 15 to 19, foams were prepared and tested as fire-fighting agents using labscale tests. All formulations contained 2.6% foamer, 1.4% C₈F₁₇SO₃⁻K⁺, 4% Witcolate 7093 surfactant, 0.85% Kelzan gum, 2% fluorochemical oligomer (as indicated in Table 4), 5% BC and 84.15% water. The Brookfield viscosity of the concentrates ranged between 1600 and 1900 cps. Premixes were made by diluting 30 g of each concentrate to 1000 g using tap water. 150 ml of each 3% premix solution was foamed in a kitchen blender for 30 seconds after which the foam was transferred into a glass flask. By air pressure the foam was added, through a plastic tube, to burning isopropanol (250 ml) after a pre-burn time of 40 seconds.

Comparative Example C-5 was made according to the general procedure described in U.S. Pat. No. 4,460,480, Example 1.

Comparative Example C-6 was made according to the general procedure described for Examples 15 to 19, using fluorochemical oligomer FC-2, but without addition of polysaccharide. Comparative Example C-7 was made according to the procedure described in JP 2121681, Example 6. In Comparative Examples C-8 and C-9, commercially available fire-fighting agents were tested: Ansulite™ 3×3 low viscosity agent (viscosity 700-2000 cps, available from Ansul, USA) in C-8 and Towalex™ 3×3 agent (viscosity 760 cps, available from Total Walther, Germany) in C-9.

Table 4 gives the composition of the fire-fighting agents tested, as well as the results of fire-extinguishment time and application rate (liter/min/m²).

TABLE 4
Composition and Performance of Fire-Fighting Foams

| | FC No. or | Extinguishment | Application Rate |
|---|---|---|---|
| Ex. No. | Product Name | time (sec) | (liter/min/m²) |
| 15 | FC-2 | 90 | 1.96 |
| 16 | FC-7 | 85 | 1.98 |
| 17 | FC-10 | 100 | 2.02 |
| 18 | FC-11 | 129 | 2.00 |
| 19 | FC-12 | 142 | 2.04 |
| C-5 | — | /** | 2.09 |
| C-6 | FC-2* | /** | 2.11 |
| C-7 | — | /** | 2.08 |
| C-8 | Ansulite™ 3x3 | 140 | 2.02 |
| | agent | | |
| C-9 | Towalex™ 3x3 | 235 | 2.08 |
| | agent | | |

Notes:
FC-2*: no polysaccharide used
/**: not possible to extinguish fire

The results in Table 4 indicate that compositions according to the invention have, in almost all cases, superior fire-fighting properties compared to the comparative examples.

### Examples 20 to 25

In Examples 20 to 25, fire-fighting concentrates were prepared containing different components and combinations as outlined in Table 5.

TABLE 5
Composition of Foam

| Components/Ex. No. | 20 | 21 | 22 | 23 | 24 | 25 |
|---|---|---|---|---|---|---|
| Fluoroaliphatic | — | — | 2.6 | — | — | 2.6 |
| aminocarboxylate(*) | | | | | | |
| Foamer | 2.6 | 2.6 | — | 2.6 | 2.6 | — |
| C₈F₁₇SO₃⁻K⁺ | 1.3 | 1.3 | 1.3 | 1.3 | 1.3 | 1.3 |
| Witcolate 7093 | 5 | 5 | — | 5 | 5 | — |
| Surfactant | | | | | | |
| SOS | — | — | 4 | — | — | — |
| SDS | — | — | 4 | — | — | 8 |
| BC | 10 | — | — | 10 | 10 | — |
| DPM | — | 10 | 10 | — | — | 10 |
| Kelzan gum | 0.9 | 0.9 | 0.9 | 0.55 | 0.35 | 0.9 |
| FC-2 | 1.5 | 1.5 | 1.5 | 2 | 2 | 1.5 |

Note:
(*): fluoroaliphatic amino carboxylate surfactant as described in U.S. Pat. No. 5,144,069, Example 1.

The concentrates were tested as foams delivered from 3% premixes in tap water. The results are given in Table 6.

TABLE 6
Properties of 3% Foam in Tap Water

| Characteristic/Ex. No. | 20 | 21 | 22 | 23 | 24 | 25 |
|---|---|---|---|---|---|---|
| Foam expansion | 8.4 | 7.5 | 7.4 | 8.6 | 8.7 | 7.8 |
| Drain time (min:sec) | 10:30 | 9:40 | 10:00 | 10:50 | 10:30 | 9:50 |
| Surface tension (N/m) | 16.7 | 16.8 | 17.1 | 16.8 | 16.7 | 17.2 |
| Interfacial tension (N/m) | 2.6 | 2.4 | 2.5 | 2.5 | 2.5 | 2.4 |
| Viscosity (cps) | 1760 | 1640 | 1880 | 740 | 440 | 1760 |

Notes: Interfacial tension: 3% tap water premix/cyclohexane
All examples passed the film spreading test on cyclohexane

The results in Table 6 indicate that a broad range of formulations can be made having low viscosity, low surface tension, good foamability and good film-forming characteristics. Good film formation is essential for fire-fighting on non-polar liquids. This will be demonstrated in Example 26.

### Example 26

In Example 26, a concentrate was prepared from 2.6% foamer, 1.3% C₈F₁₇SO₃⁻K⁺, 5% Witcolate 7093 surfactant, 1.5% fluorochemical oligomer FC-2, 0.9% Kelzan gum, 0.9% hydroxypropylated corn starch, 10% BC and water (up to 100%). The Brookfield viscosity was 1680 cps. 3% premixes were prepared using tap water and sea water as diluents. The premixes were tested as nonpolar, fire-fighting agents, according to the ISO/DIS 7203-1 test on heptane and according to the specifications for low expansion foam concentrate used to extinguish fires of water-immiscible liquids. The results are given in Table 7.

TABLE 7
Fire-Fighting Properties of Non-Polar Solvent of Example 26

| Test | Tap Water | Sea Water |
|---|---|---|
| Knockdown (sec) | 25 | 26 |
| 90% cover (sec) | 38 | 34 |
| 99% cover (sec) | 61 | 54 |
| 100% cover (sec) | 85 | 146 |

The specification requires the fire to be extinguished within 180 seconds. The concentrate passed the test when diluted to 3% with either tap water or sea water. The 3% tap water premix made from the Example 26 concentrate was further tested on heptane according to the Military Specification F 24385 F, on a 4.65 m² round pan. In Comparative Example C-10, a 3% tap water premix made from Ansuliteυ 3×3 fire-fighting concentrate was fire-tested. The results are given in Table 8.

TABLE 8
Fire-Extinguishing Properties on Heptane

| Test | Ex. 26 | C-10 |
|---|---|---|
| 40 sec summation | 354 | 309 |
| fire-extinguishment | 34 | 42 |
| 25% burnback | 555 | 390 |

The data in Tables 7 and 8 indicate that, on nonpolar solvents, a 3×3 foam agent of the present invention is superior in fire performance to a state-of-the-art commercially available 3×3 agent.

### Examples 27 to 31

In Examples 27 to 31 fire-fighting concentrates were prepared containing varying amounts of the fluorochemical oligomer FC-2. All concentrates contained 2.6% foamer, 1.4% C₈F₁₇SO₃⁻K⁺, 4% Witcolate 7093 surfactant, 0.85% Kelzan gum, 5% BC and the amount of FC-2 indicated in Table 9. Water was added up to 100%. The solutions had viscosities between 1600 and 1900 cps.

The fire-extinguishing properties of the examples were tested in the same way as Examples 15 to 19. The results are given in Table 9.

TABLE 9
Fire-Fighting Properties of 3% Foam

| | | | Application Rate |
|---|---|---|---|
| Ex. No. | % FC-2 | Extinguishment time (sec) | (liter/min/m²) |
| 27 | 4 | 98 | 1.94 |
| 28 | 2 | 90 | 1.96 |
| 29 | 1.5 | 94 | 1.98 |
| 30 | 1 | 110 | 2.00 |
| 31 | 0.5 | 140 | 2.08 |

The results in Table 9 indicate that formulations containing even small amounts of fluorochemical oligomer show fast fire-extinguishment.

### Example 32 and Comparative Examples C-11 to C-13

In Example 32 and Comparative Examples C-11 to C-13, fire-fighting tests were done on a large scale. Example 32 comprises fluorochemical oligomer FC-2 in the same composition as Example 15. The fire-fighting properties were compared to commercially available 3×3 fire-fighting agents. Comparative Example C-11 was run with Finiflam™ 3×3 fire-fighting agent, available from Pima, Germany. Comparative Example C-12 was run with Ansul™ LV 3×3 agent, available from Ansul, USA. Comparative Example C-13 was run with Universal Gold™ 3×3 agent, available from Chubb-National, UK. For the test, 3% premixes were made from concentrates using tap water and the agents were foamed through a modified mil spec nozzle. The foams were tested in the modified Nordtest type 023 test, using a 2.65 m² pan with 180 l acetone (at a temperature of 3° C.) as fuel. The outside temperature at the time of the test was 5° C. The fuel pre-burn time was one minute. Each foam was applied to the burning fuel under type II application against a backboard. The application rate was 4.4 L/min/m²; the foam application time was four minutes unless otherwise noted. After completion of foam application and a one minute holding time, 50% burnback time was measured by reigniting a small pan filled with acetone, and positioning it in the middle of the foam blanket. The time needed for 50% of the fuel surface to burn again was recorded as 50% burnback time. The results of the fire-fighting test are given in Table 10.

TABLE 10
Modified Nordtest Type 023 Fire-Fighting Test

| | 50% cover | 90% cover | 99% cover | 100% cover | 50% |
|---|---|---|---|---|---|
| Ex. No. | (sec) | (sec) | (sec) | (sec) | burnback⁽¹⁾ |
| 32 | 46 | 66 | 85 | 134 | pass |
| C-11 | 176 | 202 | 228 | 294⁽²⁾ | pass |
| C-12 | 44 | 73 | 114 | 174 | pass |
| C-13 | 288 | 336 | 390 | 456⁽³⁾ | pass |

Notes:
(1): if the burnback time is more than 300 sec., the sample passes the test
(2): total foam application time of 6 min.
(3): total foam application time of 8 min.

The data in Table 10 indicates that the fire-fighting agents of the present invention have superior extinguishment properties compared to the state-of-the-art commercially available products. The extinguishment of the fire is significantly better and the burnback resistance is high.

### Examples 33 to 35 and Comparative Examples C-14 to C-15

In Examples 33 to 35, freeze-protected fire-fighting concentrates were made and evaluated. The agents were prepared by mixing 2.6% foamer, 1.3% C₈F₁₇SO₃⁻K⁺, 5% Witcolate 7093 surfactant, 10% BC, 1% (Example 33) or 1.5% (Example 34) or 2% (Example 35) of fluorochemical oligomer FC-2, 0.85% Kelzan gum, 0.85% hydroxypropylated corn starch, 22.5% ethylene glycol and water (up to 100% total). In Comparative Example C-14 Ansulite™ 3×3 agent (which is not freeze protected) was tested. Comparative Example C-15 was made with Towalex™ 3×3 freeze-protected fire-fighting agent. The foam agents were tested in the modified Nordtest type 023 test as for Example 32. This time, the outside temperature was 29° C., which represents a highly demanding test condition (i.e., a relatively high temperature). The temperature of the fuel was 19° C. The results of the fire-fighting tests are given in Table 11.

TABLE 11
Fire-Fighting Properties of Freeze Protected Agents

| | | | | | 50% |
|---|---|---|---|---|---|
| | 50% cover | 90% cover | 99% cover | 100% cover | burnback |
| Ex. No. | (sec) | (sec) | (sec) | (sec) | (sec) |
| 33 | 102 | 165 | 168 | 238 | pass |
| 34 | 65 | 165 | 192 | 225 | pass |
| 35 | 85 | 128 | 158 | 215 | pass |
| C-14 | 110 | 280 | 365 | 410(*) | / |
| C-15 | 395 | 445 | (**) | / | / |

Notes:
(*): foam applied for 410 sec (instead of 240 sec)
/(**): foam applied for 500 sec (instead of 240 sec), but no fire extinguishment
/: no fire extinguishment

The data in Table 11 indicate that under high demanding conditions (high temperature), the foam compositions of the present invention are far more efficient than the commercially available state-of-the-art products. The comparative examples did not pass the 50% burnback test.

### Examples 36 to 39

Examples 36 to 39 were run to show that it is possible to make useful foam concentrates containing different polysaccharides. The concentrates for all examples were made by mixing 2.6% foamer, 1.3% C₈F₁₇SO₃⁻K⁺, 1.5% fluorochemical oligomer FC-2, 5% Witcolate 7093 surfactant, 0.9% hydroxypropylated corn starch, 10% BC and 0.9% polysaccharide. The polysaccharides used were as follows: in Example 34: polysaccharide K8A13, available from Kelco; in Example 35: xantham gum E 415 food grade, available from Jungbunzlauer, Austria; in Example 36: Keltrol™ gum, available from Kelco; and in Example 37: Kelzan™ gum, available from Kelco. The concentrate and 3% premix foam properties are given in Table 12.

TABLE 12
Foam Formulations Comprising Different Polysaccharides

| Property\Ex. No. | 36 | 37 | 38 | 39 |
|---|---|---|---|---|
| Viscosity (Cps) | 1960 | 1820 | 1800 | 1600 |
| Foam expansion in tap water | 13.3 | 8.8 | 10.8 | 10.2 |
| Foam expansion in sea water | 11.2 | 7.5 | 9.3 | 8.7 |
| Drain time in tap water (sec) | 400 | 430 | 490 | 500 |
| Drain time in sea water (sec) | 360 | 420 | 455 | 420 |
| Surface tension (DI-water, N/m) | 16.4 | 16.2 | 16.3 | 16.4 |
| Surface tension (sea water, N/m) | 17.3 | 17.4 | 17.4 | 17.3 |
| Interfacial tension against cyclohexane: | | | | |
| in DIW (N/m) | 3.5 | 3.9 | 3.3 | 3.0 |
| in Sea water(N/m) | 2.2 | 2.2 | 2.1 | 2.3 |

The results indicate that foam formulations containing different polysaccharides can be made according to the present invention.

Various modifications and alterations of this invention will become apparent to those skilled in the art without departing from the scope and spirit of this invention, and it should be understood that this invention is not to be unduly limited to the illustrative embodiments set forth herein.

1. A fire-fighting concentrate composition comprising
(a) a fluorochemical oligomer having a plurality of pendent fluoroaliphatic groups,
(b) one or more fluorochemical surfactant and one or more non-fluorinated surfactant,
(c) polysaccharide, and
(d) water.

2. The composition according to claim 1, wherein the fluoroaliphatic groups in the fluorochemical oligomer are linked to water solubilizing moieties selected from the group consisting of anionic, cationic, nonionic, and amphoteric moieties, and compatible combinations of such moieties.

3. The composition according to claim 1 wherein the fluoroaliphatic groups are fluorinated, saturated, monovalent, non-aromatic groups of 3 to 20 carbon atoms.

4. The composition of claim 3 wherein the fluoroaliphatic groups are fluorinated, saturated, monovalent, non-aromatic groups of 5 to 12 carbon atoms.

5. The composition according to claim 1 wherein the fluorochemical oligomer is non-ionic or amphoteric.

6. The composition according to claim 1 wherein the fluorochemical oligomer comprises 5 to 45% by weight of carbon-bonded fluorine based on the weight of the oligomer.

7. The composition according to claim 6 wherein the fluorochemical oligomer comprises 20 to 40% by weight of carbon-bonded fluorine based on the weight of the oligomer.

8. The composition according to claim 1 wherein the fluorochemical oligomer is an oligomer derived from fluorine containing (meth)acrylates and fluorine-free (meth)acrylates.

9. The composition according to claim 8 wherein the fluorochemical oligomer is further derived from monomers selected from the group consisting of fluorine-containing (meth)acrylamides and fluorine-free (meth)acrylamides.

10. The composition according to claim 1 wherein the fluorochemical oligomer has an average molecular weight of 2,000 to 50,000.

11. The composition according to claim 10 wherein the fluorochemical oligomer has an average molecular weight of 2,000 to 20,000.

12. The composition according to claim 11 wherein the fluorochemical oligomer has an average molecular weight of 2,000 to 10,000.

13. The composition according to claim 1 wherein the concentration of fluorochemical oligomer in the composition is an amount from 0.3 to 5% by weight.

14. The composition according to claim 13 wherein the concentration of fluorochemical oligomer in the composition is an amount from 0.5 to 4% by weight.

15. The composition according to claim 1 wherein the concentration of the polysaccharide in the composition is an amount of 0.1 to 3% by weight of the concentrate composition.

16. The composition according to claim 15 wherein the concentration of the polysaccharide in the composition is an amount of 0.2 to 1.5% by weight of the concentrate composition.

17. The composition according to claim 1 which is a 3×3 fire-fighting composition.

18. A method of extinguishing polar or non-polar liquid fires comprising the steps of diluting, aerating, and applying to the surface of said liquid an effective amount of a composition according to claim 1 for extinguishing said fire.

19. A method of extinguishing polar or non-polar liquid fires comprising the steps of diluting, aerating, and applying to the surface of said liquid an effective amount of a composition according to claim 8 for extinguishing said fire.

20. A method of extinguishing polar or non-polar liquid fires comprising the steps of diluting, aerating, and applying to the surface of said liquid an effective amount of a composition according to claim 11 for extinguishing said fire.

21. A method of extinguishing polar or non-polar liquid fires comprising the steps of diluting, aerating, and applying to the surface of said liquid an effective amount of a composition according to claim 12 for extinguishing said fire.

22. The use of a fluorochemical oligomer having a plurality of pendant fluoroaliphatic groups in combination with a polysaccharide in a 3×3 fire-fighting concentrate composition for extinguishing both polar and non-polar solvent fires.
